(19) United States
(12) Patent Application Publication
(10) Pub. No.: US 2014/0053870 A1
(43) Pub. Date: Feb. 27, 2014

(54) CLEANING WIPE COMPRISING A SPUNBONDED WEB

(71) Applicants: Scott J. Tuman, Woodbury, MN (US); Cordell M. Hardy, Woodbury, MN (US); Steven J. Botzet, Hudson, WI (US)

(72) Inventors: Scott J. Tuman, Woodbury, MN (US); Cordell M. Hardy, Woodbury, MN (US); Steven J. Botzet, Hudson, WI (US)

(73) Assignee: 3MM INNOVATIVE PROPERTIES COMPANY, ST. Paul, MN (US)

(21) Appl. No.: 14/004,053

(22) PCT Filed: May 8, 2012
(86) PCT No.: PCT/US12/36939

§ 371 Date: Sep. 9, 2013

Related U.S. Application Data
(60) Provisional application No. 61/486,376, filed on May 16, 2011.

(51) Int. Cl. A47L 13/16; B29D 7/01

(52) U.S. Cl. CPC A47L 13/16; B29D 7/01
USPC 134/6; 15/209.1; 156/167

(57) ABSTRACT

Herein is disclosed a cleaning wipe comprising an activated spunbonded nonwoven web, and methods of making and using such cleaning wipes.

### BACKGROUND

Cleaning wipes comprised of nonwoven webs are commonly used in the cleaning of surfaces. However, spunbonded nonwoven webs, as made, have not been generally perceived as well suited for efficiently capturing and/or retaining particles, since the spunbonding process typically forms relatively thin webs without a large number of protruding fibers and/or fiber segments.

### SUMMARY

Herein is disclosed a cleaning wipe comprising an activated spunbonded nonwoven web, and methods of making and using such cleaning wipes. In one aspect, herein is disclosed a cleaning wipe comprising an activated spunbonded web comprising a multiplicity of slits. In another aspect, herein is disclosed a method of making a cleaning wipe, comprising: meltspinning fibers, solidifying the fibers and collecting the solidified fibers to form a fiber mat; bonding at least some of the fibers of the fiber mat to each other to transform the fiber mat into a spunbonded web; and, activating the spunbonded web to form at least one cleaning wipe. In still another aspect, herein is disclosed a method of cleaning a surface, comprising: securing a wipe comprising an activated spunbonded web to a cleaning tool so that a working face of the wipe is exposed; and, slidably moving the working face of the wipe across a surface to be cleaned.

These and other aspects of the invention will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

FIG. 1 is a side cross-sectional view of an exemplary wipe comprising an activated spunbonded web.

FIG. 2 is a top plan view of an exemplary wipe comprising an activated spunbonded web

FIG. 3 is a side cross-sectional view of an exemplary wipe comprising an activated spunbonded web that comprises an exemplary compressively melt-bonded site.

FIG. 4 is a magnified view of an exemplary wipe comprising an activated spunbonded web that comprises an exemplary autogeneously melt-bonded site.

FIG. 5 is a side cross-sectional view of an exemplary spunbonded web.

FIG. 6 is a side cross-sectional view of an exemplary spunbonded web which has been cut to comprise a plurality of slits.

FIG. 7 is a top plan view of another exemplary wipe comprising an activated spunbonded web.

FIG. 8 is a top plan view of another exemplary wipe comprising an activated spunbonded web.

FIG. 9 is a top plan view of another exemplary wipe comprising an activated spunbonded web.

FIG. 10 is a top plan view of a portion of an exemplary wipe comprising exemplary slits, with the wipe in an untensioned condition.

FIG. 11 is a top plan view of a portion of an exemplary wipe comprising exemplary slits, with the wipe in a tensioned condition.

FIG. 12 is a diagrammatic representation of an exemplary process for making a wipe comprising an activated spunbonded web.

FIG. 13 is a perspective view of an exemplary wipe wrapped around an exemplary cleaning tool and secured to the tool.

FIG. 14 is a side view of an exemplary wipe comprising an optional backing layer.

FIG. 15 is a side view of an exemplary wipe comprising optional added fibers on the working face of the wipe.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular, the dimensions of the various components are depicted in illustrative terms only, and no relationship between the dimensions of the various components should be inferred from the drawings, unless so indicated. Although terms such as “top”, bottom“, “upper”, lower“, “under”, “over”, “front”, “back”, “outward”, “inward”, “up” and “down”, and “first” and “second” may be used in this disclosure, it should be understood that those terms are used in their relative sense only unless otherwise noted.

### DETAILED DESCRIPTION

Glossary

By “cleaning wipe” is meant a free-standing sheet-like finished good that may be mounted onto a cleaning tool for cleaning of a surface.

By “activated” is meant a spunbonded web that has been subjected to a cutting process so as to contain a plurality of slits, and is further meant that the slit-containing web has been processed (e.g., mechanically worked) so as to at least increase the number of fiber ends and/or fiber segments that protrude outward from a working face of the web.

By “spunbonded” is meant a web comprising a set of meltspun fibers that has been collected as a fiber mat and then subjected to one or more bonding processes to bond at least some of the meltspun fibers to each other.

By “meltspun” is meant fibers that have been formed by extruding molten filaments out of a set of orifices and allowing the filaments to cool and solidify to form continuous fibers, with the filaments passing through an air space and/or an attenuation unit in which the filaments may be at least partially drawn.

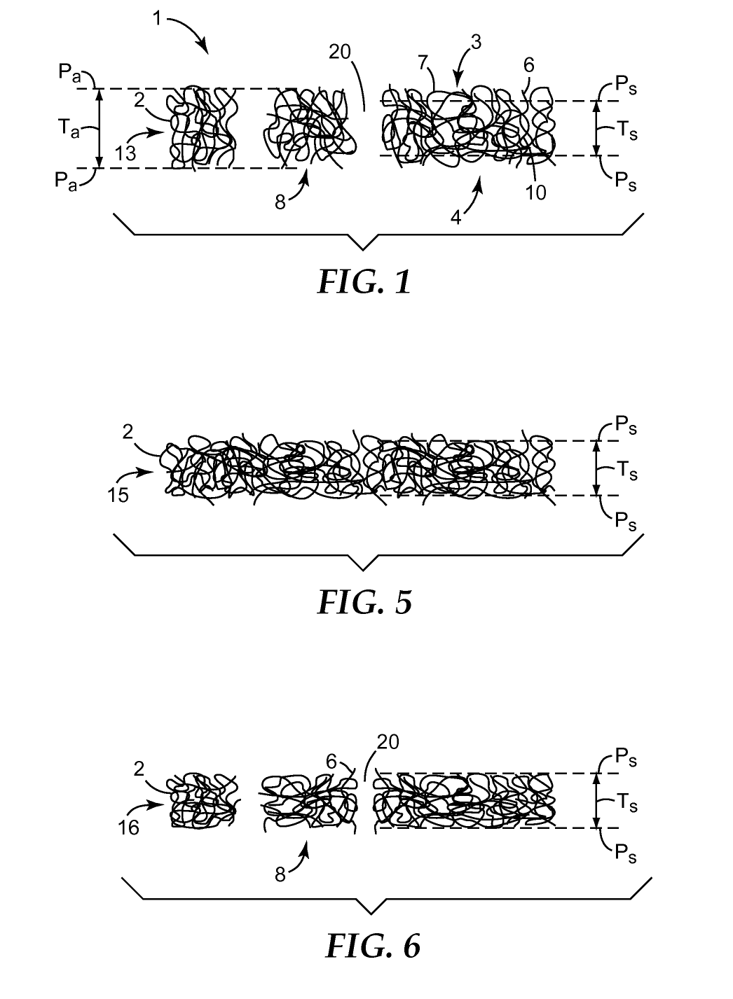

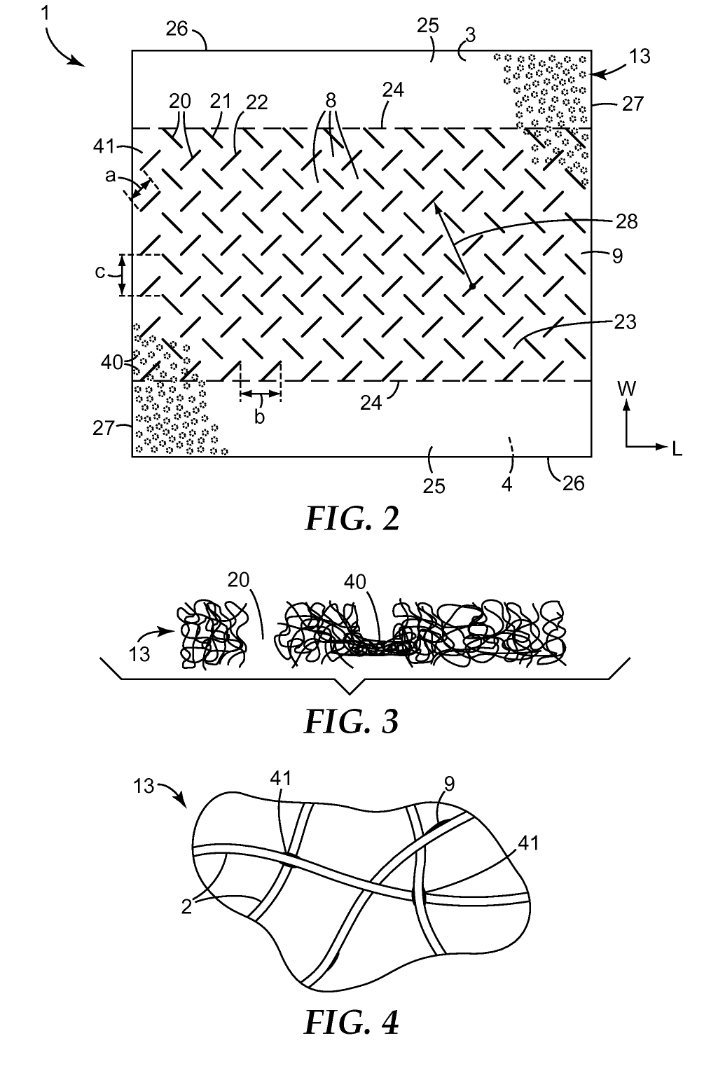

Shown in side cross-sectional view in FIG. 1, and in top plan view in FIG. 2, is an exemplary cleaning wipe 1 comprising an activated spunbonded web 13 comprised of meltspun fibers 2. Cleaning wipe 1 is a free-standing finished good, meaning that as supplied to a user, wipe 1 is not a part of, or connected to, any other structure (other than, e.g., packaging materials, and/or other wipes 1, in the event that wipes 1 are collectively supplied as a roll good). Wipe 1 may comprise major working face 3, major (oppositely-facing) rear face 4, major ends 26 and minor ends 27, and interior 10.

At least some portions of at least some melt-spun fibers 2 may be bonded to each other (e.g., in order to transform an initially collected fiber mat into a self-supporting fiber web that can be handled, processed, etc.). Such bonding may be performed by any suitable method, including for example the use of adhesive binders (whether in the form of liquids, particulates, fibers, etc.), hydroentanglement, needle-punching, and the like. In some embodiments, the bonding may be performed by melt-bonding at least some of fibers 2 to each other, e.g. by compressively melt-bonded (i.e., thermally point-bonded) sites and/or by autogeneously melt-bonded sites. An exemplary compressively melt-bonded site 40 of activated spunbonded web 13 is illustrated in FIG. 3. By compressively melt-bonded site is meant an area of web 13 in which portions of at least several (e.g., numerous) fibers 2 have been heated and pressed against each other so as to melt-bond to each other, often to the extent that the fiber portions are significantly deformed and commingled with each other and may no longer be individually identifiable. In many cases, the fiber portions may be flattened together to form an area of relatively densified material, as shown in exemplary manner in FIG. 3. Such compressive melt-bonding is often performed e.g. by passing a fibrous web between a calendering roll and a backing roll (one or both of which may be heated), the calendering roll bearing protrusions, outer surfaces of which may press fiber portions against the backing roll so as to melt and bond the fiber portions to each other as described above. Such compressive melt-bonding may also be assisted e.g. by ultrasonic energy, as will be well known to those of ordinary skill.

In various embodiments, compressively melt-bonded sites 40 of web 13 may occupy at least about 2%, at least about 4%, or at least about 6%, of the (length×width) area of web 13. In further embodiments, compressively melt-bonded sites 40 of web 13 may occupy at most about 25%, at most about 20%, or at most about 15%, of the area of web 13. In various embodiments, compressively melt-bonded sites 40 of web 13 may comprise, on average, a lateral dimension (in the plane of web 13) of less than about 1.5 mm, of less than about 1.2 mm, or of less than about 0.8 mm. In further embodiments, compressively melt-bonded sites 40 of web 13 may comprise, on average, a lateral dimension of at least about 0.10 mm, of at least about 0.20 mm, or of at least about 0.40 mm. In various embodiments, compressively melt-bonded sites 40 may be arranged at a spacing (i.e., an average center-to-center spacing) of at least about 1 mm, of at least about 2 mm, or of at least about 3 mm. In further embodiments, the compressively melt-bonded sites may be arranged at a spacing of at most about 120 mm, of at most about 90 mm, or of at most about 60 mm. The compressively melt-bonded sites may be arranged e.g. on a square array, a rectangular array, a staggered (e.g., hexagonal) array, a random or irregular array, and so on. (In this and all other uses of the term array, the term is not limited to a regular or uniform arrangement.) The arrangement (e.g., spacing) of melt-bonded sites 40 may be chosen in consideration of the slitting pattern employed, as discussed in detail later herein.

An exemplary autogeneously melt-bonded site 41 of activated spunbonded web 13 is illustrated in magnified view in FIG. 4. By an autogeneously melt-bonded site is meant that portions of fibers 2 have been heated and contacted with each other so as to melt-bond to each other, without the application of solid contact pressure that is typically used in compressive melt-bonding. Such autogeneous melt-bonding is often achieved by so-called through-air bonding, in which a nonwoven web is exposed to a stream of heated air, as described e.g. in U.S. Pat. No. 7,279,440 to Berrigan. Autogeneous melt-bonding may often cause portions of two fibers to melt-bond to each other at their location of intersection (contact), as shown in exemplary manner in FIG. 4, although occasionally portions of three or more fibers may be melt-bonded together. Often, autogeneous melt-bonding may result in the formation of a larger number of melt-bonded sites, of smaller size, in comparison to compressive melt-bonding.

Compressively melt-bonded (i.e., thermally point-bonded) sites 40, autogeneously melt-bonded sites 41, or a combination of both, may be present in web 13 of wipe 1. In some embodiments, melt-bonding (of either or both of the above-described types) between fibers 2 may be the only bonding mechanism (e.g., in various embodiments, fibers 2 of web 13 may not be hydroentangled or needle-punched, binders may not be added, etc.).

Web 13 of wipe 1 is a spunbonded web. Those of ordinary skill in the art will appreciate that due to the nature of the spunbonding process (e.g., with the fibers typically becoming solidified before being collected), a conventional spunbonded web may exhibit relatively little three-dimensional structure. That is, a conventional spunbonded web may be relatively flat, with the majority of the fibers of the web lying generally in the plane of the web and being aligned therewith. (Such a process and resulting web may be contrasted with e.g. meltblowing, in which at least some of the fibers often melt-bond to each other prior to being collected, such that they may form a more lofty, three-dimensional structure upon being collected.) A conventional spunbonded web, as made, thus may not be generally considered to be well suited for capturing of dust particles. Thus, spunbonded web 13 as disclosed herein is an activated spunbonded web, meaning that it has been subjected to a cutting process so as to contain a plurality of slits 20 that extend at least 60% of the distance through the nominal thickness of the web, and further meaning that the slit-containing web has been processed (e.g., mechanically worked) so as to at least increase the number of fiber ends and/or fiber segments that protrude outward from a working face of the web. Activation of a spunbonded web as described herein can enhance the ability of the spunbonded web to capture and retain dust particles, as evidenced in the Working Examples herein.

An activated spunbonded web 13 can be conveniently characterized with reference to FIGS. 1, 5 and 6. In FIG. 5 is pictured an exemplary conventional (unactivated) spunbonded web 15. Planes “Pₛ” as shown in FIG. 5 are imaginary planes that are each proximate to a major face of spunbonded web 15 and outwardly beyond which relatively few fiber ends or fiber segments protrude. Planes “Pₛ” collectively define the nominal thickness “Tₛ” of spunbonded web 15. In FIG. 6 is pictured a spunbonded web 16 that has been cut so as to contain slits 20. Such cutting may result in the formation of (cut) fiber ends 6 in proximity to slits 20. Due e.g. to forces encountered in the cutting process, a number of these fiber ends 6 may extend beyond one or both imaginary planes “Pₛ” of original (uncut) spunbonded web 15, as illustrated in exemplary manner in FIG. 6.

Activated spunbonded web 13 of FIG. 1 can be obtained e.g. by mechanically working, as described later herein, at least the slit-containing area of cut spunbonded web 16 of FIG. 6. Activated web 13 can be distinguished e.g. by an increased number of protruding fiber ends 6 and/or fiber segments 7 that extend outwardly beyond one or both imaginary planes “Pₛ” of original spunbonded web 15. Specifically, in comparison to slit-containing (but not yet mechanically worked) spunbonded web 16, activated spunbonded web 13 may not only exhibit protruding fiber ends 6 in areas proximate to slits 20, but may also exhibit an increased number of protruding fiber ends 6 and/or protruding fiber segments 7 in areas 8 of activated spunbonded web 13 that are in between (i.e., not proximate to) slits 20. It has been found that this increased number of protruding fiber ends and/or fiber segments, not just in proximity to slits 20 but also in other areas 8 of working face 3 of wipe 1, appears to enhance the ability of wipe 1 to capture and/or retain dust particles, as evidenced by the Working Examples presented later herein. Furthermore, this can be achieved while preserving the mechanical integrity of the web, e.g. by providing an appropriate density and arrangement of fiber-bonded sites in relation to the density and arrangement of slits 20, as discussed later herein.

It has also been found the activation process may result in at least some expansion of the thickness of the spunbonded web. That is, activated web 13 as pictured in FIG. 1, may comprise a nominal thickness “Tₐ” (between planes “Pₐ ” proximate the major surfaces of the activated web) that is greater (e.g., at least 10% greater, at least 20% greater, or at least 30% greater) than nominal thickness “Tₛ” of original spunbonded web 15 from which it was produced. That is, rather than merely causing fiber ends and/or segments proximate surfaces of a web to protrude therefrom to an increased extent, the activation process may cause expansion of at least some of interior portion 10 of the web, e.g., may increase the average distance between individual fibers 2 of the web. Such an effect may impart increased loft to activated web 13, may result in enhanced capacity of the activated web to retain dust particles, and so on, which may be desirable.

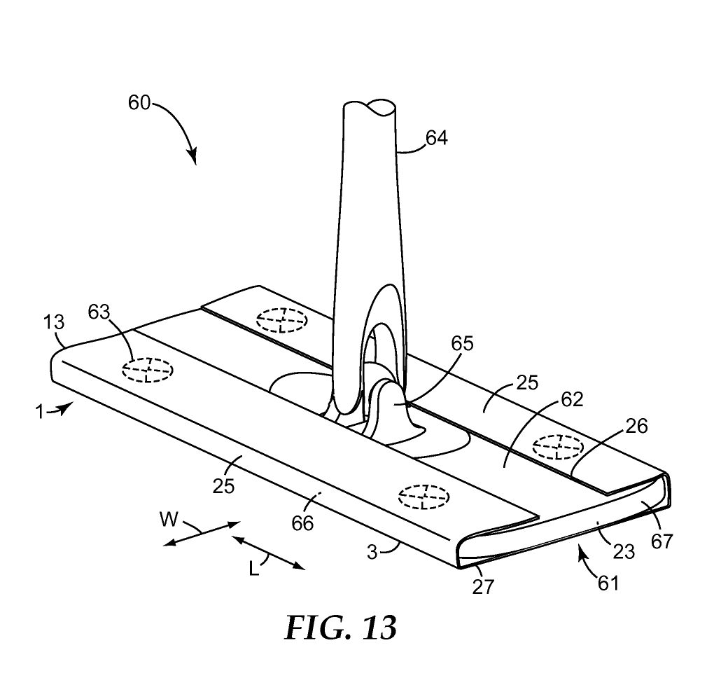

As shown in FIG. 2, activated spunbonded web 13 comprises a multiplicity of slits 20 in slit-containing area 23, bounded by perimeter 24, of web 13. Slit-containing area 23 may conveniently extend, if desired, across the entire width “L” of wipe 1 (width “L” being in the direction orthogonal to the wrap direction “W” along which wipe 1 is wrapped around cleaning tool 60, as illustrated in FIG. 13). Slit-containing area 23 may extend along the entirety of wrap direction “W”; or (as exemplified in FIG. 2), unslit border area(s) 25 may be provided between slit-containing area 23 and one or both major ends 26 of wipe 1. (Areas 25 of wipe 1 may in many cases be wrapped around the backside 62 of a cleaning tool 60 (as pictured in exemplary manner in FIG. 13) and so may not necessarily need to be activated in the same manner as area 23 of working face 3 of wipe 1.) Slits 20 by definition extend through at least 60% of the nominal thickness “Tₐ” of activated web 13. In various embodiments, slits 20 may extend through at least about 80%, or at least about 90%, of the nominal thickness “Tₐ” of activated web 13. In particular embodiments, slits 20 are through-slits which pass through the entire thickness of spunbonded web 13 from major working face 3 to major rear face 4, as shown in FIG. 1. (As such, in particular embodiments in which wipe 1 consists of (a single layer of) activated spunbonded web 13, such through-slits will pass through the entirety of wipe 1.) Those of skill in the art will realize that this condition does not necessarily preclude a small number of fibers passing across a through-slit, since the cutting of fibers is a statistical process that may not necessarily cut every single fiber (additionally, a subsequent mechanical working process described later herein, may result in at least some fibers protruding into, or even bridging across, a through-slit). Nevertheless, through-slits may be distinguished e.g. from partial-slits that do not extend through the entire thickness of a spunbonded web.

Slits 20 as disclosed herein have closed ends. As such, they are distinguished from slits that comprise at least one open end (that is, an end that terminates at an edge of a web) and that consequently allow portions of the web on opposite sides of the slit to move significantly in opposite directions to each other, out of the plane of the web. Such open-ended slits, which are often used to provide e.g. fringe mops and the like, may of course be optionally present in wipe 1, in addition to closed-end slits 20.

Slits 20 may comprise any suitable length. In various embodiments, slits 20 may comprise an average length of at least about 1 mm, at least about 2 mm, or at least about 4 mm. In further embodiments, slits 20 may comprise an average length of less than about 16 mm, less than about 12 mm, less than about 8 mm, or less than about 6 mm.

In some embodiments (e.g., of the general type exemplified in FIG. 2), slits 20 may be linear. In other embodiments, slits 20 may be nonlinear, e.g. comprised of two or more linear segments, or of an arcuate shape, or comprised of two or more arcuate segments, and so on. In such cases, the length of such slits (e.g., as used to calculate a length:width aspect ratio) can be obtained by adding the length of the individual segments, or by following the curved path of the arcuate segment(s).

In some embodiments, slits 20 may comprise an aspect ratio of slit length to slit width of at least 3:1, as measured when activated spunbonded web 13 is in an untensioned condition. In various embodiments, slits 20 of wipe 1 may comprise an aspect ratio of at least 4:1, at least 5:1, or at least 8:1, when web 13 is in an untensioned condition. In further embodiments, slits 20 may comprise an aspect ratio of no more than about 20:1, when web 13 is in an untensioned condition. (For purposes of illustration, length “l” and width “ω” of an exemplary slit 21 are illustrated in FIG. 11, in this case with the web in a tensioned condition for ease of presentation)

Slits 20 may be present at any suitable spacing. In various embodiments, slits 20 may be provided at an average center-to-center spacing (e.g., between neighbors) of at least about 2 mm, at least about 4 mm, or at least about 5 mm. In further embodiments, slits 20 may be provided at an average center-to-center spacing of at most about 14 mm, at most about 10 mm, or at most about 6 mm. Slits 20 may be provided on a square array, a rectangular array, a staggered array, an irregular or random array, etc., as desired. Different populations of slits may be present on different, overlapping (offset) arrays.

A slit 20 may comprise a major axis. In the case of a linear slit, the major axis will be the long axis of the slit. In the case of a nonlinear slit (i.e., a segmented, e.g. zigzag, slit; an arcuate slit; or the like) the major axis will be a straight line drawn between the two terminal ends of the slit, or drawn along a longest segment of the slit, whichever is greater. In the case of a branched slit (e.g., a slit having more than two terminal ends), if a main (longest) axis is apparent (e.g., the slit comprises a T shape), this will be the major axis. If a branched slit is symmetric (e.g., the slit comprises a + shape), no major axis may exist.

In some embodiments, slits 20 may be provided in a multidirectional array, defined herein as meaning that web 13 comprises a least a first plurality of slits that are oriented in a first general direction, and a second plurality of slits that are oriented in a second general direction that is at least 45 degrees away from the first general direction. By a plurality of slits is meant two or more. By a general direction is meant within an angular arc of about 45 degrees. By oriented in a general direction is meant that, if a slit is linear or otherwise has an identifiable major axis, its major axis is oriented in that general angular direction; or, if a slit is nonlinear and no major axis is identifiable, at least a long axis of at least one segment of the slit is oriented in that general angular direction. A multidirectional array does not encompass a design in which all segments of all slits, or all major axes of all slits, are within 45 degrees of the segments or major axes of all other slits. Thus, a multidirectional array does not encompass e.g. a plurality of purely parallel slits. In some embodiments, a multidirectional array may be configured so that at least 50% (by number), at least 80%, at least 90%, or all, of slits 20 each differ in angular orientation from their nearest neighbor slits by at least 25 degrees.

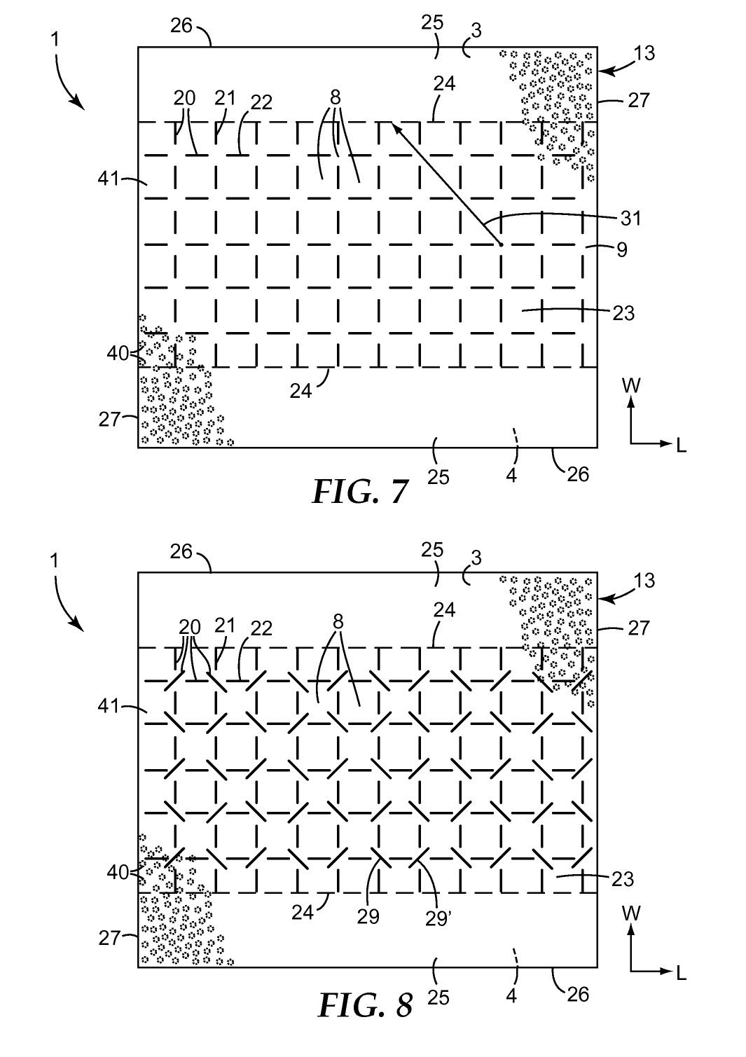

In some embodiments, slits 20 may be provided in an at least partially closed array, meaning that at least about 60% of slit-containing area 23 (bounded by perimeter 24) is area from which no straight line can be drawn which passes between at least two slits 20 to any point on perimeter 24 of slit-containing area 23 without eventually encountering at least a portion of at least one slit. (For an illustration of a line drawn from a location of a slit-containing area 23, passing between at least two slits 20, and encountering a portion of a slit prior to reaching perimeter 24, see exemplary line 28 of FIG. 2. For an illustration of a line drawn from a location of a slit-containing area 23, to a segment of perimeter 24, while passing between at least two slits 20, without ever encountering a portion of a slit, see exemplary line 31 of FIG. 7.) In further embodiments, at least about 80%, or at least about 90%, of slit-containing area 23 meets this condition. In particular embodiments, slits 20 may be provided in an essentially closed array, meaning that at least about 95% of slit-containing area 23 meets this condition.

The arrangement of slits 20 may also be characterized in terms of a longest uninterrupted distance. In some embodiments, slits 20 may be arranged so that the longest uninterrupted distance from any slit 20 is less than about 20 mm, meaning that from any point on any slit 20, it is not possible to draw a straight line in any direction (other than outward through perimeter 24 of slit-containing area 23) that extends more than 20 mm without encountering a portion of another slit 20. (Such an exemplary straight line 28, drawn from a randomly selected slit 20 and extended to the point at which it encounters another slit 20, is shown in exemplary manner in FIG. 2.) In various embodiments, the longest uninterrupted distance of such an array may be about 15 mm, about 10 mm, or about 7.0 mm. It will be apparent that the spacing, length and/or shape of slits 20 may be varied as desired so as to achieve a partially closed array or an essentially closed array, and/or to provide a desired longest uninterrupted distance between slits 20.

As mentioned, wipe 1 may comprise any suitable slit pattern. That is, any desired combination of the above-mentioned slit shapes, spacings, orientations, etc., can be used. By way of specific example, FIG. 2 depicts an exemplary design in which slits 20 are linear, and are present in a multidirectional array comprising two pluralities (i.e. populations) 21 and 22, each with a long axis that is oriented approximately orthogonally to that of the other population. Slit populations 21 and 22 are arranged on overlapping (offset) approximately square arrays that collectively comprise an at least partially closed array, and that further collectively comprise a longest uninterrupted distance that corresponds approximately to line 28 (no scale being shown).

FIG. 7 depicts another exemplary design, in which slits 20 are linear and are present in a multidirectional array comprising two populations (21 and 22) of slits, each with a long axis that is generally orthogonal to the other. Slit populations 21 and 22 are arranged on overlapping (offset) approximately rectangular arrays.

FIG. 8 shows another exemplary multidirectional array design in which a third and a fourth population (29 and 29′) of linear slits 20 are provided, which are oriented approximately orthogonally to each other and are also oriented at generally different angles (in this case, off by approximately 45 degrees) from first and second populations 21 and 22. Slit populations 21, 22, 29 and 29′ are arranged on overlapping, offset arrays.

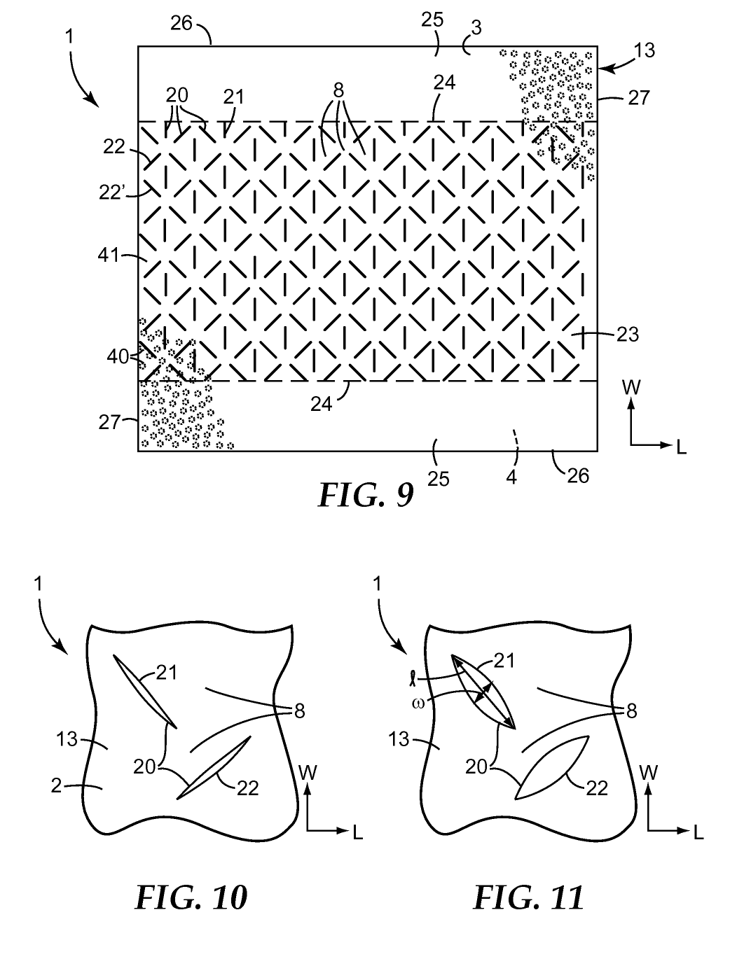

FIG. 9 depicts an exemplary multidirectional array design in which slits 20 are linear, and are present in three populations (21, 22 and 22′), the slits of each of which are oriented in a direction that is at least approximately 45 degrees away from the direction of the slits of the other two populations, and which are arranged on overlapping, offset arrays.

Those of ordinary skill will appreciate that many other designs and arrangements of multidirectional arrays, at least partially closed or essentially closed arrays, and the like, may be envisioned, with the patterns presented herein being merely representative examples. For instance, while the above-discussed figures portray slits which are present in e.g., two, three or four populations, each population being comprised of numerous slits of essentially the same length, orientation, spacing, etc., in other embodiments many more populations may be present, and/or may be comprised of slits of varying length, orientation, spacing, etc.

Providing slits 20 in a multidirectional array may present advantages in addition to potentially allowing the achieving of an at least partially closed or essentially closed array. These advantages may result from the fact that tensioning of a slit spunbonded web along a direction that is not aligned with a long axis of a slit may result in at least some expanding of the width of the slit (as demonstrated by exemplary slits 21 and 22 of FIG. 11, in a web which is under tension, in comparison to the web in an untensioned condition as shown in FIG. 10). Such expanding of slit width (e.g., by way of wipe 1 being at least slightly tensioned while in use for cleaning a surface) may enhance the dust particle capturing and/or retaining efficiency of an activated spunbonded web. Providing slits 20 in the form of a multidirectional array with at least two populations at generally different orientations (e.g., that differ by at least 45 degrees, with 90 degree-differing (orthogonal) populations 21 and 22 being exemplified in FIGS. 2, 10 and 11) may ensure that, no matter along which direction a web may be tensioned during use, the tensioning may cause at least some slits to experience width expansion.

In particular embodiments of this general type, the orientation of slit populations may be chosen in relation to the wrap direction “W” and lateral width “L” of a wipe 1. For example, in the exemplary design of FIGS. 2, 10, and 11, slits 20 are present in two populations 21 and 22, both of which (in addition to being generally orthogonal to each other) are oriented at an off-angle (defined as being off by at least 25 degrees) from the wrap direction “W” of wipe 1. As shown in greater detail in FIGS. 10 and 11, the application of tension to wipe 1 along wrap direction “W” (which may occur during wrapping and/or securing of wipe 1 to a cleaning tool) may result in width expansion for not just one, but both, of slit populations 21 and 22, which may be advantageous.

In various specific embodiments, wipe 1 may comprise first plurality of slits 21 that are oriented at first angles that are from about 30 degrees to about 60 degrees away from the wrap direction “W” of wipe 1, and a second plurality of slits 22 that are oriented at second angles that differ from the first angles and that are also from about 30 degrees to about 60 degrees away from wrap direction “W” of wipe 1. One exemplary representation of this is shown in exemplary manner in FIG. 2, in which slits 21 and 22 are each oriented approximately 45 degrees off-axis (in different directions) from wrap direction “W” of wipe 1.

It will be apparent that in at least some of the embodiments described herein the cutting to form slits may provide a shortened average fiber length. That is, those of ordinary skill will appreciate that melt-spun fibers, as made and formed into a web, are generally considered to be continuous except for e.g. such broken fibers and fiber ends as are statistically expected to occur occasionally. (Such continuous fibers, e.g. with an average length of at least about 5 cm, 10 cm, 20 cm, or even longer, are to be contrasted e.g. with staple fibers which are typically provided as chopped to a given, e.g. predetermined, length of e.g. 2 cm or less before being formed into a web). Based on the disclosures herein, the providing of numerous slits 20 (e.g., particularly through-slits that are of sufficiently long length and close enough spacing so as to provide an at least partially closed array), might be expected to result in a significant shortening of the average fiber length of melt-spun fibers 2 in web 13. That is, it might be expected that, after such a cutting process, few fibers would remain of length greater than the above-described longest uninterrupted distance between slits; in fact, it might be expected that a large proportion of the fibers would have a length no greater than the average spacing of the slits.

In appreciation of this, it has been found useful to provide that web 13 contains fiber-bonded sites, e.g. melt-bonded sites, in sufficient quantity, and/or at sufficiently close spacing, so that web 13 still comprises acceptable mechanical integrity even after a cutting (and e.g. mechanically working) process. In such case, even though the average fiber length may be relatively short, a sufficient number of fiber-bonded sites may be present so that the majority of the fibers comprise at least e.g. one or two bonds to other fibers over this length. This may be achieved, for example, by the use of bonded sites (e.g., compressively melt-bonded sites 40) that are present e.g. at an average spacing that is less than the longest uninterrupted distance between slits 20 of the slit array. In further embodiments, compressively melt-bonded 40 sites may be present at an average spacing that is about the same as, or less than, the average spacing of slits 20 (e.g., as shown in exemplary manner in FIG. 2). In specific embodiments of this type, slits 20 may comprise an average spacing of from about 4 mm to about 10 mm, and compressively melt-bonded sites 40 may comprise an average spacing of from about 2 mm to about 10 mm.

The above-described effect may also be achieved by the use of autogeneously melt-bonded sites 41. It will be appreciated that autogeneous melt-bonding may often generate more, and more closely spaced, melt-bonds in comparison to the more widely-spaced melt-bonds typically achieved by compressive melt-bonding. Thus, the autogeneous melt-bonding process is well suited for achieving a suitable melt-bond density; it is only necessary to carry out the autogeneous melt-bonding sufficiently aggressively that a sufficient number of such bonds are formed.

In some embodiments, both autogeneous and compressive melt-bonding can be performed in combination to achieve the desired effects (often, in such cases, it may be convenient to autogeneously melt-bond a melt-spun web and then to perform the compressive melt-bonding).

In summary, it has been discovered that the use of slitting, e.g. through-slitting, so as to shorten the average length of fibers of a spunbonded web may provide that upon subsequent processing, e.g. mechanical working of the web, fiber segments and/or fiber ends may be loosened so as to protrude outward so as to enhance the ability of a spunbonded web to capture and/or retain dust particles (in addition, the overall thickness of the web may be increased, as discussed previously). At the same time, the providing of sufficient bonds, e.g. melt-bonds, can ensure that fibers are not dislodged from the web (e.g. during use of the web in cleaning) to an unacceptable extent. That is, e.g. cutting, mechanical working, and melt-bonding as described herein, can be used in synergy to unexpectedly allow these conflicting objectives to be achieved.

Specifically, it can be seen e.g. in comparing the percentage debris pickup achieved by Working Example 8 (an inventive activated spunbonded web) to that of Control Examples 5-7 (which are respectively, an as-produced spunbonded web, a web which has been mechanically worked only, and a web which has been cut only), that an unexpectedly high synergistic effect of the inventive activation process and activated web (in comparison to either a cutting or a mechanically working process being performed alone) is demonstrated. Similar trends may be observed in comparison of Working Example 4 to Control Examples 1-3 (with the trend not being as pronounced, possibly due to the higher amount of point-bonding in Samples 1-4). Similarly, comparison of Working Example 10 to Comparative Example 9, and likewise 12 to 11 and 14 to 13, reveals again an unexpected synergistic effect of the herein-claimed activation process and webs produced thereby, over webs that are subjected only to a cutting process.

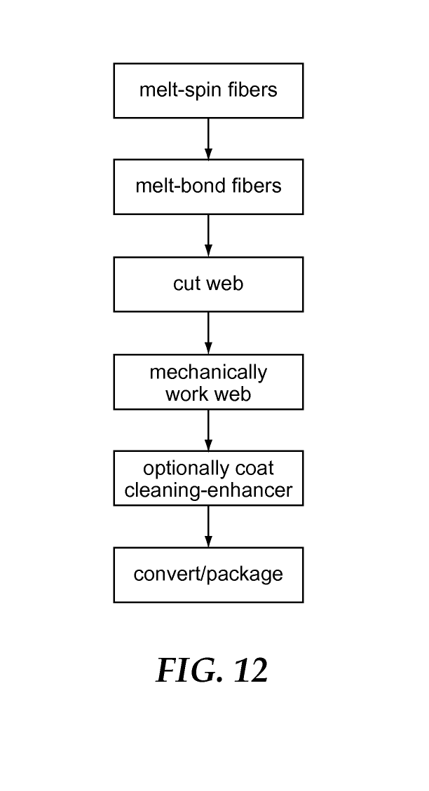

An exemplary method of making wipe 1 is shown in diagrammatic representation in FIG. 12. A spunbonded web (e.g., web 13 as shown in FIG. 5) may be produced by any conventional melt-spinning and bonding (e.g., compressive melt-bonding and/or autogeneous melt-bonding) process, as are well known. The spunbonded web (which those of ordinary skill will readily distinguish from e.g. a meltblown web, staple-fiber web, a carded web, an air-laid or wet-laid web, etc.) may then be cut to provide slits 20 in the desired configuration. While any suitable cutting method may be used, it may be convenient to provide a die, e.g. a rotary die, with blades that correspond to the desired slit configuration, and to pass the web over the die in such manner as to perform the cutting. The spunbonded, slit-containing web may then be e.g. mechanically worked to complete the activation process.

By mechanically working of slit-containing, spunbonded web 16 is meant applying force (e.g. in a direction generally along the plane of the web) to at least some of the fibers of the web, so as to cause at least some fiber ends and/or fiber segments to protrude outward from the web, and/or to increase the thickness of the web, as described herein. Such mechanical working may be performed in any suitable manner.

In some embodiments, mechanical working may be performed by applying tension to web 16. Such tension may be applied (e.g. along the machine direction of the web, along the cross-web direction of the web, or both, or along any suitable direction in between these two extremes) to slit-containing web 16, e.g. before it is separated into individual wipes 1. For example, machine-direction tension may be applied e.g. by controlling the force and/or speed with which a winding roll is used to roll up the slit-containing web, as will be well-known to those of ordinary skill. Cross-web tension may applied e.g. by the use of a tentering apparatus, again as is well-known. In certain embodiments, tension may be applied to slit-containing web 16 after it has been separated into discrete wipes 1. This may be performed e.g. at the factory by use of a stretching frame or the like.

In some embodiments, mechanical working may be performed by causing major working face 3 of web 16, and a frictional surface, to move relative to each other while at least portions of working face 3 come into contact with, and/or remain in contact with, portions of the frictional surface. Such movement may be achieved by motion of web 16 relative to the frictional surface, by motion of the frictional surface relative to web 16, and/or some combination of both. The mechanical interaction between the frictional surface and major working face 3 of web 16 may cause fiber ends and/or fiber segments to become loosened and to protrude from the web in the manner described previously. In embodiments in which slits 20 are partial-slits that do not extend through the entirety of the thickness of the spunbonded web, it may be desirable to perform the frictional mechanical working on the side of the spunbonded web from which the cutting was performed.

The frictional surface can be any suitable surface of any suitable member and can be brought into contact with major working face 3 of web 16 in any suitable manner. For example, the frictional surface might be a surface (e.g., rubber, foam or the like) of a stationary platen or bar across which web 16 is dragged. Or, the frictional surface might be the surface of a frictional roller, e.g. a rubber-coated roll, over which web 16 is passed at a differential speed (i.e., with the speed of web 16 differing at least slightly from the rotation speed of the roll). Such a roller might be part of a nip through which web 16 is passed, with the frictional roller rotating at a faster speed than the speed of web 16, at a slower speed, or even counter-rotating relative to the movement of web 16.

In some embodiments, a frictional surface may be provided collectively by a plurality of bristles, e.g. of a brush-roller across which web 16 is passed. Such a brush-roller may comprise e.g. numerous bristles of a suitable composition (e.g., synthetic or natural fibers, metals, and so on), and might be rotated at any suitable speed to achieve the desired effect.

In general, frictional surfaces may be divided into two categories; soft and hard. Soft frictional surfaces may include e.g. organic polymeric bristles or surfaces (including e.g. rubber coatings and the like). Such soft frictional surfaces may achieve the above-described loosening of fiber ends and/or fiber segments, but in general may not necessarily cut a significant number of fibers (beyond those already cut in the previous cutting process) and may not work individual fibers in such manner as to stretch them, to cause them to assume a helical configuration, or the like. Hard frictional surfaces may include e.g. metal bristles of a brush-roller, or one or more hard metal bars, edges, or even blades over which web 16 is passed. Such processes may not only cause loosening of fiber ends and/or fiber segments; they may also cut at least some fibers to produce new fiber ends. (If so, this should not be performed to such an extent as to cause fibers to become unacceptably dislodgable from the web.) Passing web 16 over a hard frictional surface may also significantly work individual fibers so as to cause them to stretch, to assume a helical configuration, or the like. While the use of hard frictional surfaces may fall within the scope of a mechanical working portion of an activation process as disclosed herein, it is understood that this will only be the case when such a mechanical working process follows, as a subsequent and separate step (although possibly being performed in-line), a cutting process that produces slits as described elsewhere herein. That is, drawing of a web over a hard frictional surface which both cuts fibers and loosens them does not in and of itself constitute an activation process as disclosed herein. Furthermore, in general, an activation process as described herein is distinguished from any process that both cuts and dislodges fibers in a single operation. For example, the use of metal bristles to perform mechanical work on a web as disclosed herein may be distinguished from e.g. needle-punching in which a metal needle penetrates into a web, cuts fibers, and dislodges fibers, in a single operation.

However achieved, activation as disclosed herein may not necessarily increase the elongation of activated spunbonded web 13 (in comparison to unactivated spunbonded web 15) by a relatively large amount. In various embodiments, the % linear elongation of activated spunbonded web 13 (i.e., in response to the application of a mild tensioning force, as might be achieved by stretching activated spunbonded web 13 by hand along a major axis) may be no more than about 20%, no more than about 15%, no more than about 10%, or no more than about 5%. As such, activated spunbonded web 13 may be distinguished from a web that has been cut and/or mechanically worked so as to significantly increase the elongation of the web, e.g. so that the web may be coupled with a highly elastic substrate for use e.g. in a diaper closure or a like item.

In many instances, it may be convenient to maintain a slit-containing spunbonded web 16 as a roll good, and to pass it, while in this form, over one or more frictional surfaces and/or to apply mechanical tension to it. One convenient in-line way of applying downweb mechanical tension is to pass the web through a rotary die to perform the cutting and therefrom to wind the web on a takeup roll that is oversped to a rotation speed that is e.g. from 104% to 110% of the speed of the web through the rotary die. (However, depending e.g. on the nature of the particular web, such processes may not necessarily impart any significant mechanical working of the web, as discussed in the Examples herein). Crossweb tensioning may likewise be performed in-line via use of a tentering apparatus. (However, the tensioning of a web in roll form, and/or passing it over a frictional surface, may be done as a separate operation rather than in-line with a cutting operation.) Alternatively, either the tensioning and/or passing the web over a frictional surface may be done piecewise, after the web has been separated from a roll good e.g. into individual wipes.

It may be convenient to carry out at least some of the above-described processing (activating, and optional coating of a cleaning-enhancing coating) while the spunbonded web is in the form of a roll good e.g. with a width that is wide enough to accommodate multiple (at least two) wipes 1. After the processing is performed, the roll good can then be cut lengthwise into individual rolls, e.g. with each individual roll being one wipe wide. These individual rolls can be packaged such that an end user can remove individual wipes therefrom (e.g., by separating a wipe from the roll along a line of weakness (e.g., a perforated line) running across the width of the roll). Alternatively, the rolls can be separated (converted) into individual wipes in the factory, which wipes can then be stacked and packaged, as illustrated in FIG. 12.

In various embodiments, wipe 1 may have a thickness of at least 0.1 mm, at least about 0.2 mm, or at least about 0.3 mm. In further embodiments, wipe 1 may have a thickness of no more than about 1.0 mm, no more than about 0.7 mm, or no more than about 0.5 mm. In various embodiments, wipe 1 may have a basis weight of at least about 20 grams per square meter (gsm), at least about 40 gsm, or at least about 50 gsm. In further embodiments, wipe 1 may have a basis weight of no more than about 150 gsm, no more than about 100 gsm, or no more than about 80 gsm. In various embodiments, meltspun fibers 2 of activated spunbonded web 13 of wipe 1 may comprise an average fiber diameter of at least about 4, 8 or 12 microns, and of at most about 30, 20, or 15 microns.

Although wipe 1 may be held in the hand for cleaning if desired, in many cases it may be convenient to use wipe 1 in combination with a cleaning tool 60 as shown in exemplary manner in FIG. 13. Cleaning tool 60 comprises major working surface 61 which is configured to accommodate at least a portion of slit-containing area 23 of wipe 1 with working face 3 of wipe 1 facing outward. Border areas 25 (which may be, but do not have to be, unslit areas) of wipe 1 may be wrapped along wrap direction “W” (as shown in FIG. 13) around major wrap ends 66 of cleaning tool 60, and secured to backside 62 of cleaning tool 60. Pinch holes 63 may be conveniently provided in backside 62 so that portions of border areas 25 can be inserted therein and held (although any suitable securing method and mechanism may be used). Tension may be applied to wipe 1 (e.g., along the wrap direction “W”) in the act of wrapping and/or securing wipe 1 to cleaning tool 60, if desired. It may be convenient for minor ends 27 of wipe 1 to be configured to be approximately even with minor ends 67 of cleaning tool 60. Cleaning tool 60 may comprise handle 64 with rotatable (either along a single plane, or multidirectional) connection 65 to cleaning tool 60. With wipe 1 secured in place cleaning tool 60 may be placed against a surface to be cleaned (e.g., a floor) and slidably moved (e.g., by way of handle 64) over the surface to remove debris therefrom.

In some embodiments wipe 1 may be configured so that major working face 3 is activated and major rear face 4 is not. However, in other embodiments major rear face 4 may also be activated so that, if desired, a user can clean with wipe 1 for a time, then can reverse wipe 1 on cleaning tool 60 so that major face 4 of wipe 1 now faces out, and can clean using this face of the wipe for an additional time. Although in the exemplary illustrations used herein wipe 1 is shown with a wrap direction “W” that is aligned with a short axis of wipe 1, wrap direction “W” can, if desired, be aligned with a long axis of wipe 1, e.g. depending on the particular configuration of cleaning tool 60 with which wipe 1 is to be used. (Or, in some instances, wipe 1 might be generally square.)

Meltspun fibers 2 of web 13 may be comprised of any suitable thermoplastic (melt-processable) resin or mixtures thereof. In some embodiments, the thermoplastic resin(s) may be selected from conventional (e.g., synthetic) materials. In other embodiments, the thermoplastic resin(s) may be selected from materials that are renewable, i.e. plant-derived. Mixtures of both may of course be used. The fibers may be monocomponent, or multicomponent (e.g., bicomponent), as desired.

In some embodiments, the thermoplastic resin(s) may be selected from materials such as polypropylenes, polyethylenes, aromatic polyesters (e.g., poly(ethylene) terephthalate (PET), poly(ethylene) terephthalate glycol (PETG), poly(butylene) terephthalate (PBT), poly(trimethyl) terephthalate (PTT), their copolymers, or combinations thereof), and the like.

In some exemplary embodiments, the thermoplastic polyester comprises at least one aliphatic polyester. In certain exemplary embodiments, the aliphatic polymer may be selected from one or more poly(lactic acid), poly(glycolic acid), poly(lactic-co-glycolic acid), polybutylene succinate, polyethylene adipate, polyhydroxy-butyrate, polyhydroxyvalerate, and blends and copolymers thereof. In certain exemplary embodiments, the aliphatic polyester(s) may be semicrystalline. In compositions which include thermoplastic polymers which are not aliphatic polyesters, the aliphatic polyester may be present e.g. at a concentration of greater than 70% by weight of the total thermoplastic polymer, greater than 80% by weight of the total thermoplastic polymer, or greater than about 90% by weight of the total thermoplastic polymer.

In some embodiments, at least about 60% of the fibers of web 13, by weight, are made of plant-derived material(s). In some embodiments, fibers 2 of web 13 consist essentially of plant-derived material(s). In certain embodiments, they consist essentially of aliphatic polyester(s). In specific embodiments, they consist essentially of poly (lactic acid).

Methods of making spunbonded webs comprising plant-derived materials, aliphatic polyesters, poly (lactic acid), and the like, are described e.g. in U.S. patent application Ser. No. 12/971,186 to Moore et al.

Fibers 2 and/or web 13 may comprise any additive(s) that may improve the processability, stability, etc. of the web. Such additives may include e.g. antishrink additives, surfactants, stabilizers, plasticizers, processing aids, antioxidants, and so on. Wipe 1, e.g. activated spunbonded web 13 thereof, may also comprise any suitable additive(s) which may enhance the cleaning performance thereof. In some embodiments, a cleaning-enhancing coating 9 may be coated onto major working face 3 of wipe 1, and/or coated at least partially into interior 10 of web 13, so as to be present on at least some surface portion of some fibers 2, as shown in exemplary illustration in FIG. 4. In some embodiments, cleaning-enhancing coating 9 may comprise a pressure-sensitive adhesive composition, e.g. obtained by coating a water-borne pressure-sensitive adhesive onto major working face 3 and allowing the water to dry. In other embodiments, cleaning-enhancing coating 9 may comprise an oil or wax. Conventional oils or waxes (e.g., silicone oil, paraffin wax, and the like) may be used. In some embodiments, cleaning-enhancing coating 9 may be a plant-derived material, e.g. an oil or wax such as soy oil, partially or completely hydrogenated soy oil, soy wax and so on. Any such cleaning-enhancing coating 9 may be applied to the web at any desired point in the above-described production process. It may be most convenient to perform such coating operation while the web is still in the form of a roll good.

Any other additives may be used if desired, for example waxes, polishes, pest control ingredients, antimicrobial agents, disinfectants, dyes, colorants, fragrances, soaps, detergents, abrasives and the like. Any or all of such additives may be plant derived; or, they may be present in such low amounts so as not to detract from any compostability of wipe 1. In some embodiments, wipe 1 may be pre-wetted with a cleaning agent in such manner that it can be used for wet-cleaning of surfaces, as opposed to dry-cleaning.

In some embodiments, at least some components of wipe 1 may be compostable. In certain embodiments, wipe 1 exhibits at least about 30% degradation by weight within 180 days, when tested according to the general procedures outlined in ASTM D6400 (Standard Specification for Compostable Plastics) as specified in 2004. In further embodiments, wipe 1 exhibits at least about 60% degradation by weight within 180 days, when tested according to the general procedures of ASTM 6400 as specified in 2004.

In some embodiments, wipe 1 may consist of a single layer of activated spunbonded web 13 (including any additives, coatings, etc. thereof). In other embodiments, wipe 1 may comprise multiple spunbonded webs 13 e.g. that are layers of a spunbonded-meltblown-spunbonded (SMS) multilayer assembly. In such cases, in some embodiments only one (e.g., an outermost spunbonded layer at the working face of wipe 1) may be an activated layer; or, in other embodiments, all of the spunbonded layers may be activated.

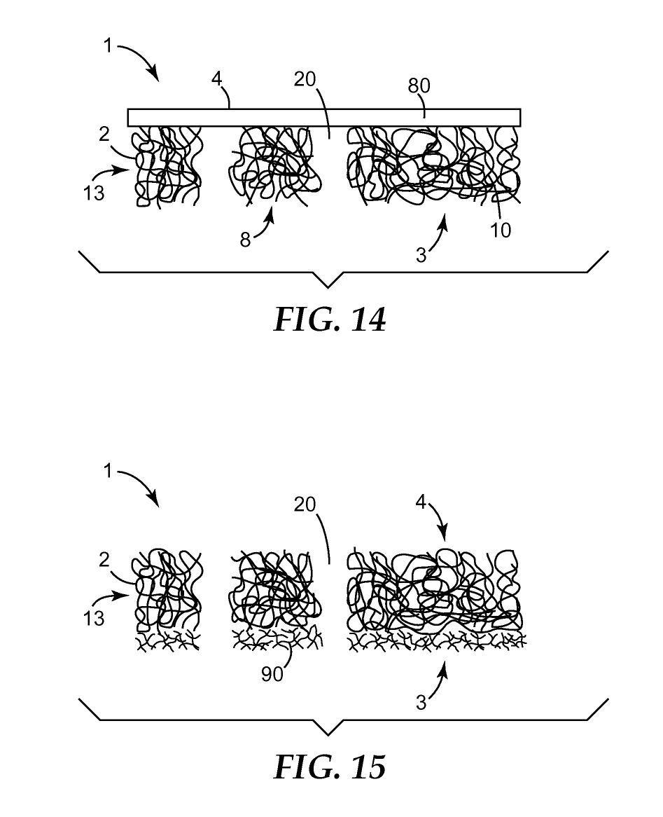

In some embodiments, an optional backing layer 80 may be provided on a side of activated spunbonded web 13 that is opposite working face 3, as shown in the exemplary illustration of FIG. 14. Such an additional backing layer 80 may comprise any suitable substrate, and e.g. may take the form of a dense film, a fibrous web, and so on. In some embodiments, backing layer 80 may be in contact with the majority of major rear face 4 of web 13 (as distinguished from configurations in which portions of a web project outward from a backing layer with an air space or gap therebetween). If present, backing layer 80 may be melt-bonded, e.g. in discrete locations, to web 13. Layer 80 may be comprised of a synthetic polymeric material, a plant-derived polymeric material, and so on.

In some embodiments, optional discontinuous fibers 90 (e.g., chopped/staple fibers) may be provided upon major working face 3 of activated spunbonded web 13, as shown in the exemplary illustration of FIG. 15. Fibers 90 may be deposited (e.g. as loose fibers rather than as a pre-existing web) upon major working face 3 either before or after web 13 is cut and/or mechanically worked, and may be held thereon by any suitable method including e.g. melt-bonding and so on. Fibers 90 may be synthetic fibers, natural fibers, plant-derived fibers, and so on. In some embodiments, no additional fibers, e.g. no discontinuous fibers, are provided upon working face 3 of activated spunbonded web 13.

### List of Exemplary Embodiments

Embodiment 1. A cleaning wipe comprising an activated spunbonded web comprising a multiplicity of slits.

Embodiment 2. The wipe of embodiment 1, wherein the slits are arranged in a multidirectional array comprising at least a first plurality of slits that are oriented in a first general direction and a second plurality of slits that are oriented in a second general direction that is at least 45 degrees away from the first general direction.

Embodiment 3. The wipe of embodiment 2 wherein the slits of the first plurality of slits are oriented at first angles that are from about 30 degrees to about 60 degrees away from a long axis of the wipe, and wherein the slits of the second plurality of slits are oriented at second angles that are from about 30 degrees top about 60 degrees away from the long axis of the wipe.

Embodiment 4. The wipe of any of embodiments 1-3 wherein the slits comprise an average length of less than about 10 mm and wherein the slits are arranged at an average spacing of less than about 10 mm.

Embodiment 5. The wipe of any of embodiments 1-4 wherein at least some of the slits are through-slits that extend through the entire thickness of the web.

Embodiment 6. The wipe of any of embodiments 1-5 wherein the slits are configured so that a longest uninterrupted distance between slits is less than about 20 mm.

Embodiment 7. The wipe of any of embodiments 1-6 wherein the slits are configured so that a longest uninterrupted distance between slits is less than about 10 mm.

Embodiment 8. The wipe of any of embodiments 1-7 wherein the spunbonded web comprises melt-bonded sites arranged so that an average distance between adjacent melt-bonded sites that is less than a longest uninterrupted distance between slits.

Embodiment 9. The wipe of embodiment 8 wherein the spunbonded web comprises compressively melt-bonded sites that are arranged at an average spacing that is less than an average spacing of the slits.

Embodiment 10. The wipe of embodiment 9 wherein the compressively melt-bonded sites occupy from about 4% to about 15% of the area of the spun-bonded web.

Embodiment 11. The wipe of any of embodiments 1-10 wherein the slits exhibit a length to width aspect ratio of at least about 8:1 when the web is in an untensioned condition.

Embodiment 12. The wipe of any of embodiments 1-11 wherein at least about 60% of the fibers of the spunbonded web, by weight, are made of plant-derived materials.

Embodiment 13. The wipe of any of embodiments 1-12 wherein the fibers of the spunbonded web consist essentially of plant-derived materials.

Embodiment 14. The wipe of any of embodiments 1-13 wherein the wipe comprises at least one cleaning-enhancing coating.

Embodiment 15. The wipe of embodiment 14 wherein the cleaning-enhancing coating is a plant-derived material.

Embodiment 16. The wipe of any of embodiments 1-15 wherein the wipe exhibits at least 30% degradation by weight within 180 days when tested according to the procedures of ASTM D6400 as specified in 2004.

Embodiment 17. The wipe of any of embodiments 1-16 wherein the wipe exhibits at least 60% degradation by weight within 180 days when tested according to the procedures of ASTM D6400 as specified in 2004.

Embodiment 18. The wipe of any of embodiments 1-17 wherein at least 90% of the fibers of the spunbonded web, by weight, are thermoplastic aliphatic polyester fibers.

Embodiment 19. The wipe of any of embodiments 1-18 wherein the fibers of the spunbonded web consist essentially of poly(lactic acid) fibers.

Embodiment 20. The wipe of any of embodiments 1-19 wherein the wipe consists of a single layer of activated spunbonded web.

Embodiment 21. The wipe of any of embodiments 1-20 wherein the wipe comprises a spunbond-meltblown-spunbond (SMS) web.

Embodiment 22. The wipe of any of embodiments 1-21 further comprising at least one backing layer on a side of the activated spunbonded web that is opposite a working face of the activated spunbonded web.

Embodiment 23. The wipe of any of embodiments 1-22 further comprising discontinuous fibers on a working face of the activated spunbonded web.

Embodiment 24. A method of making a cleaning wipe, comprising: meltspinning fibers, solidifying the fibers and collecting the solidified fibers to form a fiber mat; bonding at least some of the fibers of the fiber mat to each other to transform the fiber mat into a spunbonded web; and, activating the spunbonded web to form at least one cleaning wipe.

Embodiment 25. The method of embodiment 24 further comprising coating a cleaning-enhancing coating onto at least some of the fibers of the web.

Embodiment 26. The method of any of embodiments 24-25 wherein the bonding comprises at least one of autogeneous melt-bonding of fibers to each other, and/or compressive melt-bonding of fibers to each other.

Embodiment 27. The method of any of embodiments 24-26 wherein the activating of the spunbonded web comprises cutting the spunbonded web so as to contain a plurality of slits, followed by mechanically working at least the slit-containing area of the spunbonded web.

Embodiment 28. The method of embodiment 27 wherein the mechanically working of at least the slit-containing area of the spunbonded web comprises either or both of a) tensioning the web; or, b) causing a major surface of the web, and a frictional surface, to move relative to each other while at least portions of the slit-containing area of the major surface of the web come into contact with, and/or remain in contact with, portions of the frictional surface.

Embodiment 29. The method of embodiment 27 wherein at least a portion of the mechanical working of at least the slit-containing area of the spunbonded web comprises at least one web-tensioning step that is performed in-line with the cutting step.

Embodiment 30. The method of embodiment 29 wherein the cutting step is performed by passing the web over a rotary die cutter and wherein the web-tensioning step comprises winding the slit-containing web onto a takeup roll which is oversped to a speed that is at least 104% of the speed of the web over the rotary die cutter.

Embodiment 31. The method of any of embodiments 24-30 wherein the activated spunbonded web is a roll good comprising a length and a width and wherein the method includes the additional step of separating individual rolls, each of which are one wipe wide, from the roll good by cutting the roll good along one or more cutting lines that are oriented down the length of the roll good and are spaced across the width of the roll good, and optionally includes the further step of cutting the individual rolls across their width to separate individual wipes therefrom.

Embodiment 32. A method of cleaning a surface, comprising: securing a wipe comprising an activated spunbonded web to a cleaning tool so that a working face of the wipe is exposed; and, slidably moving the working face of the wipe across a surface to be cleaned.

Embodiment 33. The method of embodiment 32 wherein the securing of the wipe to the cleaning tool comprises wrapping the wipe around the cleaning tool by hand along a wrap direction.

Embodiment 34. The method of any of embodiments 32-33 wherein the activated spunbonded web comprises a multiplicity of slits arranged in a multidirectional array comprising at least a first plurality of slits that are oriented in a first general direction and a second plurality of slits that are oriented in a second general direction that is at least 45 degrees away from the first general direction.

Embodiment 35. The method of any of embodiments 32-34 including the step of attaching a first major end of the wipe to the cleaning tool and wrapping the wipe around the cleaning tool along the wrap direction, during which wrapping process force is applied to tension the wipe along the wrap direction so as to cause at least some mechanical working of the wipe, after which a second major end of the wipe is attached to the cleaning tool.

Embodiment 36. The method of any of embodiments 32-35 comprising the wipe of any of embodiments 1-23.

Embodiment 37. The method of any of embodiments 32-35 comprising a wipe made by any of the methods of embodiments 24-31.

Embodiment 38. The wipe of any of embodiments 1-23 made by the method of any of embodiments 24-31.

### EXAMPLES

Debris Pick-Up Test Method

A piece of vinyl flooring measuring 4 feet×4 feet (1.21 meters×1.21 meters) was used as the test floor surface. Prior to testing the floor surface was cleaned using a two step process. First any large debris was removed with a broom. This was followed by squirting approximately 10 ml of isopropyl alcohol onto the floor surface and then wiping with a WYPALL cleaning cloth (available from Kimberly-Clark) attached to a SWIFFER Sweeper floor mop (available from Procter & Gamble). The debris used for testing was similar to household dust and small sand particles (Arizona Test Dust, nominal 70-150 microns, obtained from Powder Technology Inc., Burnsville, Minn.). Approximately 5.0 grams of debris was weighed out for deposition on the test surface. The debris was carefully sprinkled from a height of about 3 feet so that the debris could separate and individualize during the fall. Care was taken to spread the debris evenly across the floor surface. The webs to be tested were cut into sheet samples (about 216 mm×267 mm in size) and were weighed. Care was taken to minimize any affect of static on the balance. Each sample sheet was attached to the mop head of SCOTCHBRITE Floor Sweeper (Q-600, available from 3M Company, St. Paul, Minn.) so that the side of the spunbonded web having the protruding fiber ends and/or fiber segments was facing toward the floor surface. Starting at one corner of the test floor surface, the floor surface was first swept from left to right, using an up and down S pattern (serpentine) motion, ending at the opposite corner of the floor surface. During this first sweeping cycle, the mop head was kept in constant contact with the floor surface. The cleaning tool head was then gently lifted and turned so that the opposite leading edge was used for sweeping and the tool was positioned to repeat the sweeping operation using the same up and down S pattern. In this second sweeping cycle, the floor surface was swept from right to left in a direction perpendicular to the first sweeping cycle, ending at the opposite corner of where the second sweeping cycle began. During this second sweeping cycle, the mop head was kept in constant contact with the floor surface. Upon completion the second sweeping cycle, the head was gently lifted and turned so that the same leading edge that was used in the second sweeping cycle was used to sweep the perimeter of the floor surface. During all of the sweeping cycles, care was taken not to apply extra force to the cleaning tool.

The mop head was carefully lifted off the floor surface and was rotated such that the soiled sheet was facing upwards. The soiled sheet was then carefully removed from the mop head and folded inwardly to contain the collected debris. The soiled sheet was then weighed. The difference between the weight of the soiled sheet and unsoiled sheet provided the amount of debris picked up by the sheet. The amount of debris that was picked-up was then divided by the amount of debris originally spread on the test floor surface and multiplied by 100 to obtain the percent debris pick-up. By way of comparison, a commercially available product (SWIFFER SWEEPER DRY CLOTHS, available from Procter & Gamble), believed to contain a cleaning-enhancing coating, exhibited a percent debris pick-up in the range of approximately 18%.

Production of Webs

Nonwoven spunbonded webs were produced on an experimental spunbond making line and were generally made using the equipment and processing techniques for spunbond nonwovens described in U.S. Patent Publication 2008/0038976. The poly (lactic acid) resin (PLA) used to prepare the nonwoven fibers was PLA 6202D, available from Natureworks, Minnetonka, Minn., and was dried prior to use. The nonwoven fibers were obtained using a Davis-Standard BLUE RIBBON (DS-20®) extruder (Davis Standard Corporation, Pawcatuck, Conn.) using a 2.0 inch/50 mm single screw extruder to feed into through a pump to an extrusion head including multiple die orifices. The die head had a total of 1560 orifice holes with an aliphatic polyester polymer melt throughput of 0.47 g/hole/min (96.8 lbs/hr). The die had a transverse length of 18 inches (457 mm). The hole diameter was 0.0135 inch (0.343 mm) and L/D ratio of 4. The melt extrusion temperature at the die of the PLA was set at 230° C. The fibers were collected on a conventional screen support as an unbonded fiber mat, and were then passed through a through-air bonder at a temperature of 155° C. in order to cause light autogeneous bonding between at least some fibers. The basis weight of the thus-produced webs was approximately 60 grams/meter².

### Control Examples 1 and 5 (No Cutting or Mechanical Working)

The above-described webs were thermally point-bonded using conventional calendaring equipment, where the top calendar roll was a patterned roll and the bottom calendar roll was a smooth stainless steel roll. Control sample 1 was point-bonded using a patterned calendar roll having oval shaped features (feature height 1.52 mm) with a 4% bonding surface area. Control sample 5 was point-bonded using a patterned calendar roll having diamond shaped features (feature height 0.25 mm) with a 15% bonding surface area. The spunbonded webs were run through the calendar rolls at a line speed of 12.1 meters/minute. The pressure at a nip point between the pattern roll and the smooth roll was 220 pli (38.5 N/mm). The top calendar roll temperature was maintained at 102° C. and the bottom calendar roll temperature was maintained at 107° C.

### Control Examples 2 and 6 (Mechanically Worked Only)

Control samples 2 and 6 were prepared as described for Control samples 1 and 5, respectively, except that the thermally point-bonded spunbonded webs were subjected to a mechanically working process, by applying tension to each individual web sample (for convenience, this process is referred to in these Examples as “stretching”). This was performed by manually grasping the opposing major ends of a 7 cm×7cm area of the web and pulling by hand, along the major plane of the web sample and along a first major direction of the web (e.g., along the machine direction of the web as made), three times with approximately 2 lbf. This process was then repeated along a second major direction of the web (e.g., along the cross-web direction of the web as made) that was generally orthogonal to the first major direction.

### Control Examples 3 and 7 (Cut Only)

Control samples 3 and 7 were prepared as described for Control samples 1 and 5, respectively, except that the thermally point-bonded spunbonded webs were subjected to a through-cutting process to provide a plurality of slits that generally extended through the entirety of the thickness of the web. The point-bonded spunbonded webs were passed through a rotary die to perform the through-cutting. The webs were wound up on a takeup roll that was oversped to a speed that was estimated to be approximately 104-110% of the speed of the web through the rotary die. However, this winding-up process was not observed to impart any significant mechanical working to the slit area of the web (this was believed to be because the side borders of the web were not slit and thus appeared to dominate the physical strength of the web and thus to minimize any stretching that might have otherwise occurred due to the overspeeding of the takeup roll). The rotary die had a cut pattern of the general pattern shown for the wipe of FIG. 2, where distance a=4.50 mm (feature length), distance b=6.35 mm (feature spacing), and distance c=6.35 mm (feature spacing).

### Working Examples 4 and 8 (Cut and Mechanically Worked)

Working samples 4 and 8 were prepared as described for Control samples 3 and 7 except that the through-cutting process of Control samples 3 and 7 was followed by mechanical working of the samples by applying tension to the web as described for Control samples 2 and 6.

Working samples 4 and 8, and Control samples 1-3 and 5-7, were tested for debris pick-up using the test method described above. Test results are provided in Tables 1 and 2, with Table 1 illustrating webs that were point-bonded at approximately 4% bonding area and Table 2 presenting webs that were point-bonded at approximately 15% bonding area. The data represents an average of three tests.

TABLE 1

| Example | Web Condition | % Debris Pick-up |
|---|---|---|
| Control 1 | No cutting or stretching | 5.1 |
| Control 2 | Stretched only | 6.9 |
| Control 3 | Cut only | 12.9 |
| Working 4 | Cut and stretched | 15.4 |

TABLE 2

| Example | Web Condition | % Debris Pick-up |
|---|---|---|
| Control 5 | No cutting or stretching | 2.7 |
| Control 6 | Stretched only | 2.7 |
| Control 7 | Cut only | 4.8 |
| Working 8 | Cut and stretched | 10.0 |

### Control Examples 9, 11 and 13; and Working Examples 10, 12 and 14

Control Examples 9, 11 and 13 were prepared as described for Control Example 3 (4% point-bonding; cut only), and Working Examples 10, 12 and 14 were prepared as described for Working Example 4 (4% point-bonding; cut and mechanically worked), except that the webs were coated with a cleaning-enhancing additive to enhance debris pick-up and retention. The additives used were CRISCO soy oil (available from J. M. Smucker Co., Orville, Ohio), CRISCO shortening (partially hydrogenated oil, available from J. M. Smucker Co., Orville, Ohio) and soy wax (Golden Brands 464, available from Candle Science, Inc., Morrisville, N.C.). To prepare the coated webs the additive was slightly heated in heptane under agitation to form a solution (5 weight percent). The additive solution was then spray coated onto the spunbonded web using a PREVAL Spray System (#267, available from Nakoma Products, Coal City Ill.), using a back and forth motion to apply an even coating. The coating was performed after the web had been cut (in the case of Comparative Examples 9, 11 and 13) or after the web had been cut and mechanically worked (in the case of Working Examples 10, 12 and 14).

Examples 9-14 were tested for debris pick-up using the test method described above. Test results are provided in Table 3. The data represents an average of three tests.

TABLE 3

| | Additive Type and | | % Debris |
|---|---|---|---|
| Example | Coating Weight | Web Condition | Pick-up |
| Control 9 | 3 grams/meter² soy oil | Cut only | 45.1 |
| Working 10 | 3 grams/meter² soy oil | Cut and | 62.3 |
| | | stretched | |
| Control 11 | 3 grams/meter² partially | Cut only | 44.3 |
| | hydrogenated oil | | |
| Working 12 | 3 grams/meter² partially | Cut and | 57.5 |
| | hydrogenated oil | stretched | |
| Control 13 | 4 grams/meter² soy wax | Cut only | 22.8 |
| Working 14 | 4 grams/meter² soy wax | Cut and | 52.5 |
| | | stretched | |

The tests and test results described above are intended solely to be illustrative, rather than predictive, and variations in the testing procedure can be expected to yield different results. All quantitative values in the Examples section are understood to be approximate in view of the commonly known tolerances involved in the procedures used. The foregoing detailed description and examples have been given for clarity of understanding only. No unnecessary limitations are to be understood therefrom.

It will be apparent to those skilled in the art that the specific exemplary structures, features, details, configurations, etc., that are disclosed herein can be modified and/or combined in numerous embodiments. All such variations and combinations are contemplated by the inventor as being within the bounds of the conceived invention. Thus, the scope of the present invention should not be limited to the specific illustrative structures described herein, but rather extends at least to the structures described by the language of the claims, and the equivalents of those structures. To the extent that there is a conflict or discrepancy between this specification and the disclosure in any document incorporated by reference herein, this specification will control.

1. A cleaning wipe comprising an activated spunbonded web comprising a multiplicity of slits.

2. The wipe of claim 1, wherein the slits are arranged in a multidirectional array comprising at least a first plurality of slits that are oriented in a first general direction and a second plurality of slits that are oriented in a second general direction that is at least 45 degrees away from the first general direction.

3. The wipe of claim 2 wherein the slits of the first plurality of slits are oriented at first angles that are from about 30 degrees to about 60 degrees away from a long axis of the wipe, and wherein the slits of the second plurality of slits are oriented at second angles that are from about 30 degrees top about 60 degrees away from the long axis of the wipe.

4. The wipe of claim 1 wherein the slits comprise an average length of less than about 10 mm and wherein the slits are arranged at an average spacing of less than about 10 mm.

5. The wipe of claim 1 wherein at least some of the slits are through-slits that extend through the entire thickness of the web.

6. The wipe of claim 1 wherein the slits are configured so that a longest uninterrupted distance between slits is less than about 20 mm.

7. The wipe of claim 1 wherein the slits are configured so that a longest uninterrupted distance between slits is less than about 10 mm.

8. The wipe of claim 1 wherein the spunbonded web comprises melt-bonded sites arranged so that an average distance between adjacent melt-bonded sites that is less than a longest uninterrupted distance between slits.

9. The wipe of claim 8 wherein the spunbonded web comprises compressively melt-bonded sites that are arranged at an average spacing that is less than an average spacing of the slits.

10. The wipe of claim 9 wherein the compressively melt-bonded sites occupy from about 4% to about 15% of the area of the spun-bonded web.

11. The wipe of claim 1 wherein the slits exhibit a length to width aspect ratio of at least about 8:1 when the web is in an untensioned condition.

12-19. (canceled)

20. The wipe of claim 1 wherein the wipe consists of a single layer of activated spunbonded web.

21. The wipe of claim 1 wherein the wipe comprises a spunbond-meltblown-spunbond (SMS) web.

22. The wipe of claim 1 further comprising at least one backing layer on a side of the activated spunbonded web that is opposite a working face of the activated spunbonded web.

23. The wipe of claim 1 further comprising discontinuous fibers on a working face of the activated spunbonded web.

24. A method of making a cleaning wipe, comprising:
meltspinning fibers, solidifying the fibers and collecting the solidified fibers to form a fiber mat;
bonding at least some of the fibers of the fiber mat to each other to transform the fiber mat into a spunbonded web; and,
activating the spunbonded web to form at least one cleaning wipe.

25-26. (canceled)

27. The method of claim 24 wherein the activating of the spunbonded web comprises cutting the spunbonded web so as to contain a plurality of slits, followed by mechanically working at least the slit-containing area of the spunbonded web.

28. The method of claim 27 wherein the mechanically working of at least the slit-containing area of the spunbonded web comprises either or both of a) tensioning the web; or, b) causing a major surface of the web, and a frictional surface, to move relative to each other while at least portions of the slit-containing area of the major surface of the web come into contact with, and/or remain in contact with, portions of the frictional surface.

29. The method of claim 27 wherein at least a portion of the mechanical working of at least the slit-containing area of the spunbonded web comprises at least one web-tensioning step that is performed in-line with the cutting step.

30-31. (canceled)

32. A method of cleaning a surface, comprising:
securing a wipe comprising an activated spunbonded web to a cleaning tool so that a working face of the wipe is exposed; and, slidably moving the working face of the wipe across a surface to be cleaned.

33-35. (canceled)
